(19) United States
(12) Patent Application Publication
(10) Pub. No.: US 2014/0281507 A1
(43) Pub. Date: Sep. 18, 2014

(54) TECHNIQUES FOR DETECTING INCORRECT WEP KEY FOR OPEN AUTHENTICATION

(71) Applicant: barnesandnoble.com IIc, (US)

(72) Inventors: Alexandr Feldman, San Ramon, CA (US); Boris Presman, Mountain View, CA (US)

(73) Assignee: barnesandnoble.com llc, New York, NY (US)

(21) Appl. No.: 13/837,315

(22) Filed: Mar. 15, 2013

(51) Int. Cl. H04W 12/06; H04L 29/06

(52) U.S. Cl. CPC H04W 12/06; H04L 63/08
USPC 713/161

(57) ABSTRACT

Techniques for detecting reason for connection attempt failure for DHCP with an Open Key authentication (WEP) protocol are discussed.

### RELATED APPLICATIONS

This application is related to U.S. application Ser. No. ______ (Attorney Docket BN01.830US) filed Mar. 15, 2013 and titled “Apparatus for Detecting Incorrect WEP Key For Open Authentication” which is herein incorporated by reference in its entirety.

### FIELD OF THE DISCLOSURE

The present disclosure relates to communications, and more particularly to techniques for detecting incorrect WEP key for open authentication.

### BACKGROUND

Electronic devices have many forms of wireless and wired communications to communicate over a network. One example of a network protocol is DHCP (Dynamic Host Configuration Protocol (DHCP) that configures network devices so they can communicate on an IP network. If DHCP is used along with an open key authentication, such as, WEP (Wired Equivalent Privacy), an error may result due to a wrong key and connection to the access point is denied.

### SUMMARY

One embodiment of the present invention provides a method for detecting reason for connection attempt failure for DHCP with an Open Key authentication (WEP) protocol. Another embodiment provides an apparatus for detecting reason for connection attempt failure for DHCP with an Open Key authentication (WEP) protocol.

### BRIEF DESCRIPTION OF THE DRAWINGS

FIG. 1 shows a method for detecting reason for connection attempt failure, in accordance with an embodiment of the present invention.

FIG. 2 shows an apparatus for detecting reason for connection attempt failure, in accordance with one embodiment of the present invention.

### DETAILED DESCRIPTION

As previously mentioned, the claimed subject matter facilitates detecting reason for a connection attempt failure. For the sake of clarification, a STA is any device that contains an IEEE 802.11-conformant medium access control (MAC) and physical layer (PHY) interface to the wireless medium (WM).

In this method, the flowchart depicts a method to facilitate STA to receive transmitted frames. After association, the STA utilizes current WEP key to encrypt and broadcast random challenge. STA does not directly broadcast, but utilizes a unicast packet which an Access Point (AP) decrypts and retransmits over all nodes.

In an abstract view, a management utility and a detection utility may be used to facilitate detecting incorrect WEP key with open authentication.

In the flowchart, a block 104, the managemenet utility is sending command WEP_DETECT_ON to supplicant. The supplicant creates and sends WEP_DETECT with TRUE parameter to the host driver. Host driver switches DETECT_FILTER ON.

At block 106, management utility sends a challenge command CHALLENGE_SEND to the supplicant. Also, creating and sending broadcasted data packet with random challenge to the host driver.

At block 108, management utility starts WEP_DETECT_TIMER. Consequently, broadcasts WRONG_WEP_KEY and sends command WEP_DECECT_OFF.

At block 110, host driver receives broadcast packet with its own MAC address, it checks state of the WEP_DETECT_FILTER and if it ON, host driver sends received packet, if OFF, it drops the packet.

At block 112, when the supplicant receives challenge, it notifies framework by sending “WEP-DETECT-OK” event: and turns OFF BN_WEP_DETECT_FILTER by sending WEP_DETECT ioct1 with FALSE parameter to the host driver.

At block 114, when Framework receives BN_WEP_DETECT_OK it terminates BN_WEP_DETECT_TIMER.

FIG. 2 illustrates exemplary device 200. As appreciated by those skilled in the art, the device 200, can take many forms capable of operating the present invention. In a preferred embodiment the device 200 is a mobile electronic device. Device 200 can include control circuitry 500, storage 510, memory 520, input/output (“I/O”) circuitry 530, communications circuitry 540, and display 550. In some embodiments, one or more of the components of device 200 can be combined or omitted, e.g., storage 510 and memory 520 may be combined. As appreciated by those skilled in the art, device 200 can include other components not combined or included in those shown in this Figure, e.g., a power supply such as a battery, an input mechanism, etc.

Device 200 can include any suitable type of electronic device. For example, electronic device 200 can include a portable electronic device that the user may hold in his or her hand, such as a digital media player, a personal e-mail device, a personal data assistant (“PDA”), a cellular telephone, a handheld gaming device, a tablet device or an eBook reader. As another example, device 200 can include a larger portable electronic device, such as a laptop computer. The invention can also operate on a desktop computer, and can be run through a web application.

Control circuitry 500 can include any processing circuitry or processor operative to control the operations and performance of device 200. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Connection Failure Detection Module 505 includes the hardware and software required to perform the preceding method for failure detection for a timer and command instructions for the DHCP with open key authentication WEP protocol. For example, the module could include the software to issue and receive the desired commands, the timer or controlling another timer, and logic to support the creation, detection, and translation of the preceding commands.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 200, firmware, user preference information data, e.g., content preferences, authentication information, e.g., libraries of data associated with authorized users, transaction information data, e.g., information such as credit card information, wireless connection information data, e.g., information that can enable electronic device 200 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 200. Although I/O circuitry 530 is illustrated in this Figure as a single component of electronic device 200, several instances of I/O circuitry 530 can be included in electronic device 200.

Device 200 can include any suitable interface or component for allowing a user to provide inputs to I/O circuitry 530. For example, device 200 can include any suitable input mechanism, such as a button, keypad, dial, a click wheel, or a touch screen, e.g., display 550. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers, e.g., mono or stereo speakers, built into device 200, or an audio component that is remotely coupled to electronic device 200, e.g., a headset, headphones or earbuds that can be coupled to device 200 with a wire or wirelessly.

Display 550 includes the display and display circuitry for providing a display visible to the user. For example, the display circuitry can include a screen, e.g., an LCD screen that is incorporated in device 200. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 200, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from the electronic device 200 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VoIP, or any other suitable protocol.

Electronic device 200 can include one more instances of communications circuitry 540 for simultaneously performing several communications operations using different communications networks, although only one is shown in this Figure to avoid overcomplicating the drawing. For example, electronic device 200 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, device 200, can be coupled to a host device such as a cloud for data transfers, synching the communications device, software or firmware updates, providing performance information to a remote source, e.g., providing riding characteristics to a remote server, or performing any other suitable operation that can require electronic device 200 to be coupled to a host device. Several electronic devices 200 can be coupled to a single host device using the host device as a server. Alternatively or additionally, electronic device 200 can be coupled to several host devices, e.g., for each of the plurality of the host devices to serve as a backup for data stored in device 200.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A computer readable medium comprising a plurality of instructions to facilitate operation of an electronic device, the instructions to perform a process comprising:
detect a DHCP protocol;
indicate a WEP detection that is associated with a DHCP transaction; and
configure communication with the electronic device to an access point via a unicast packet.

2. The computer readable medium of claim 1 further comprising:
configure a timer based on issuance of a challenge command.

3. The computer readable medium of claim 2 wherein state of WEP detection is analyzed.

4. The computer readable medium of claim 3 wherein the timer is terminated upon acceptable state of WEP detection.

5. A computer readable medium comprising a plurality of instructions to facilitate operation of communication to an electronic device, the instructions to perform a process comprising:
detect a DHCP protocol;
indicate a WEP detection that is associated with a DHCP transaction;
utilize a WEP key to encrypt and broadcast a challenge; and
configure communication with the electronic device to an access point via a unicast packet.

6. The computer readable medium of claim 5 further comprising:
configure a timer based on issuance of a challenge command.

7. The computer readable medium of claim 6 wherein state of WEP detection is analyzed.

8. The computer readable medium of claim 7 wherein the timer is terminated upon acceptable state of WEP detection.
